(19) United States
(12) Patent Application Publication
(10) Pub. No.: US 2018/0060220 A1
(43) Pub. Date: Mar. 1, 2018

(54) FIXTURE PLUGIN FOR PRODUCT AUTOMATION

(71) Applicant: LinkedIn Corporation, Mountain View, CA (US)

(72) Inventors: YIDA YAO, Gilroy, CA (US); Weizhen Wang, Santa Clara, CA (US); Ran Ye, San Jose, CA (US); Vakwadi Thejaswini Holla, Santa Clara, CA (US)

(21) Appl. No.: 15/244,364

(22) Filed: Aug. 23, 2016

(51) Int. Cl. G06F 11/36

(52) U.S. Cl. CPC G06F 11/3684

(57) ABSTRACT

Techniques are provided for creating mock responses based on default data and mapping actual requests to those mock responses so that a service under test (SUT) may be executed within a simulated integration. In one technique, multiple example requests (ERs) that exemplify actual requests that the SUT may send during a test case are created. Each ER is configured to invoke a downstream service. For each ER, a mock downstream response that is based on default values is created. In a mapping, an association between each ER and its mock downstream response is stored. During the test, the SUT is invoked. Responsively, the SUT generates downstream requests to downstream services, regardless of actual availability. The computer intercepts each invocation of a downstream request. Based on the downstream request, the computer selects a mock downstream response from the mapping and provides the mock downstream response to the SUT.

### FIELD OF THE DISCLOSURE

The present disclosure relates to integration testing of software services. Techniques are presented for creating mock responses based on default data and mapping actual requests to the mock responses so that a service under test may be exercised within a simulated integration.

### BACKGROUND

Discovering some integration defects that degrade the behavior of software is difficult without a production ecosystem of deployed services. A production environment might only be available after a service progresses all of the way through a release cycle. A revision of source code that is committed to version control may cause a defect that is not evident during unit testing. Generally, these kinds of integration defects are difficult to isolate. For example, it can take longer to isolate a defect in source code than it takes to actually fix the defect. When a latent defect eventually emerges, some context regarding the offending commit may be lost, which can increase the time needed to isolate and fix the bug.

Some reasons why finding integration defects late in a release cycle is problematic include:

A difficulty in isolating offending commit(s);

Even after an offending commit has been identified, the semantics of the code or the logical flow might be forgotten, and it might be difficult to fix the defect without completely understanding the intent of the entirety of a commit that spans multiple source files;

The code needs to roll back from production machines;

The release cycle is reset and throws off team timelines and deliverable schedules;

Some developers may be hesitant to commit a new revision, perhaps because a release may be difficult to roll back. This can cause stress and impact the job satisfaction of a developer.

Release cycles are deliberate and long, exacerbating the issues mentioned above.

A way is needed to handle these issues before the service gets released.

### BRIEF DESCRIPTION OF THE DRAWINGS

In the drawings:

FIG. 1 is a block diagram that depicts an example computer that creates mock responses based on default data and maps actual requests to those mock responses so that a service under test may be exercised within a simulated integration, in an embodiment;

FIG. 2 is a flow diagram that depicts an example process for creating mock responses based on default data and mapping actual requests to those mock responses so that a service under test may be exercised within a simulated integration, in an embodiment;

FIG. 3 is a block diagram that depicts an example computer that incorporates request wildcarding, response cloning, and response customization to achieve flexibility and convenience, in an embodiment;

FIG. 4 is a block diagram that depicts an example system of computers that performs integration testing, in an embodiment;

FIG. 5 is a block diagram that depicts an example computer that decouples mapping creation from mapping population, in an embodiment;

FIG. 6 is a block diagram that illustrates an example computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for creating mock responses based on default data and mapping actual requests to those mock responses so that a service under test may be exercised within a simulated integration. In one technique and during a simulated integration test, one or more computers create example requests that exemplify actual requests that the service under test may send during a test case. Each example request is configured to invoke a downstream service. For each example request, the computer creates a mock downstream response that is based on default values. In a mapping, the computer stores an association between each example request and its mock downstream response. During the test, the computer also invokes the service under test. Responsive to being invoked, the service under test generates downstream requests to one or more downstream services that may or may not actually be available. For each downstream request, the computer intercepts an invocation of the downstream request. Based on the downstream request, the computer selects a mock downstream response from the mapping and provides the mock downstream response to the service under test.

An embodiment incorporates request wildcarding, response cloning, and response customization to achieve flexibility and convenience. An embodiment performs integration testing of the service under test.

An embodiment decouples creation from population for a mapping. Such decoupling may avoid and defer portions of configuring of a mapping.

### Example Computer System

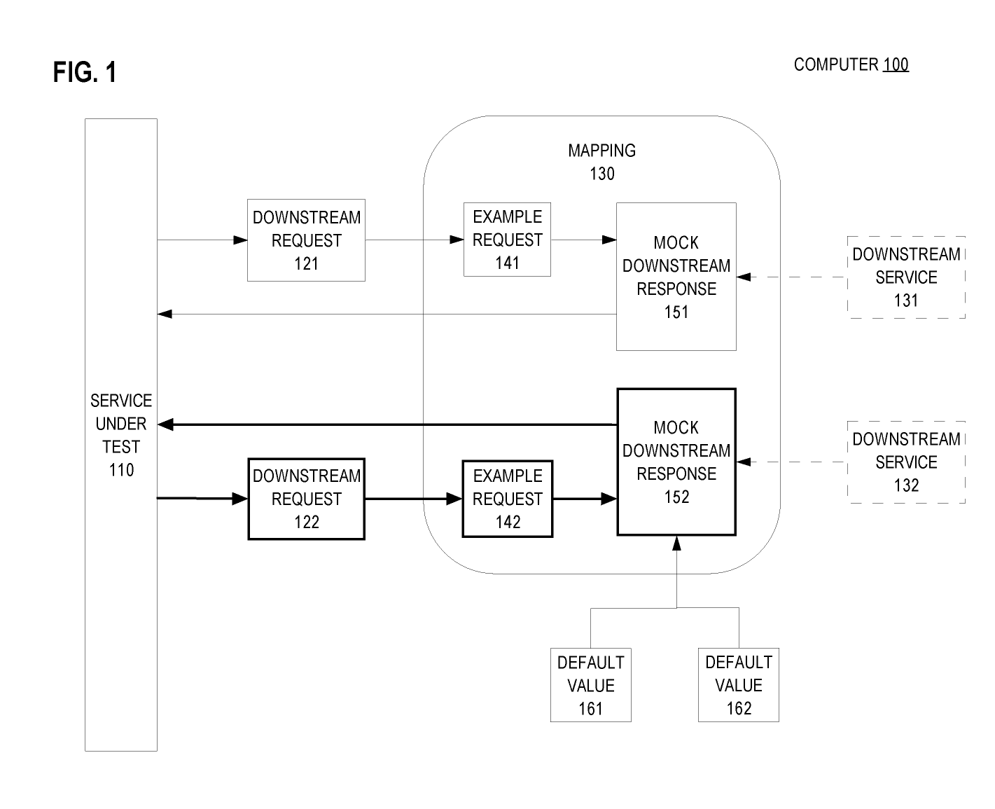

FIG. 1 is a block diagram that depicts example computer 100 that integration tests a software service, in an embodiment. Computer 100 creates mock responses based on default data and maps actual requests to those mock responses so that a service under test may be exercised within a simulated integration.

Computer 100 may be any computer or networked aggregation of computers. For example, computer 100 may be a personal computer, a rack server such as a blade, a virtual machine, or other general purpose computer.

Computer 100 includes service under test 110. Service under test 110 may be any software component that exposes a service interface and that can be instantiated within a software container such as an application server, a test harness, or other software container that may operate as a service hosting and invocation framework, such as one that inverts control.

Service under test 110 may be a bean, a component, a module, a script, or other software unit that can be decoupled from its dependencies such as downstream services 131-132 that service under test 110 may invoke. Service under test 110 may be a web service that accepts and processes a request to generate a response.

In an embodiment, service under test 110 is invoked remotely or from another operating system process. In an embodiment, service under test 110 invokes downstream services that are remote or within another operating system process, such as a different application process, such as with enterprise application integration (EAI).

In an embodiment, service under test 110 uses a low-level protocol for transport such as hypertext transfer protocol (HTTP) or Java remote method protocol (JRMP) to transfer a request or a response. In an embodiment, service under test 110 uses a high-level protocol to coordinate with other programs that are remote or within another operating system process.

In an embodiment, the high-level protocol is synchronous, such as a remote procedure call (RPC) protocol, such as representational state transfer (REST), simple object access protocol (SOAP), or Java remote method invocation (RMI). In an embodiment, the high-level protocol is asynchronous, such as protocol buffers or Java message service (JMS). In an embodiment, requests and responses bear data that is encoded according to a marshalling format such as extensible markup language (XML), JavaScript object notation (JSON), or Java object serialization.

In this example, service under test 110 is of unproven quality and deployed in some monitored environment, such as a developer laptop, a test laboratory, or a production data center.

### Example Topology

In operation, computer 100 may exercise service under test 110 to detect integration defects that ordinarily would involve interfacing (integrating) with downstream services. An integration defect may impact the behavior of service under test 110 in a way that causes any observable deviation from expected behavior. Expected behavior may be established theoretically or by observing an earlier version of service 110 that is approved as a behavioral baseline.

During an integration test, computer 100 may invoke service under test 110. For example, service under test 110 may be part of an online social network that provides participant profiles upon demand. For example, computer 100 may send to service under test 110 an HTTP request to retrieve a profile of a particular participant.

In a live production environment, service under test 110 may be integrated within an ecosystem of live services. An invocation of service under test 110 may cause service under test 110 to delegate work to downstream services, such as 131-132, that reside within the ecosystem. For example, the ecosystem may have a service-oriented architecture (SOA) and/or an enterprise service bus (ESB).

In this example, providing a participant profile may require service under test 110 to retrieve career data from one data service and social graph data from another data service. As such, service under test 110 may delegate work to downstream services, such as data retrieval from disparate sources.

For example, downstream service 131 may provide data about social connections between participants. For example, service under test 110 may send downstream request 121 to downstream service 131 to determine which participants are connected to a particular participant. For example, downstream requests 121-122 may be XML or JSON documents.

Furthermore, downstream service 132 may retrieve career data. For example, service under test 110 may send downstream request 122 to downstream service 132 to retrieve a professional summary of the particular participant or a connected participant.

However, service under test 110 is unproven, potentially defective, and so may unintentionally break or degrade downstream services with which service under test 110 may attempt to interact. For example, it may be hazardous for service under test 110 to send a defective downstream request to a live downstream service that facilitates a high-traffic or high-revenue website or performs other mission-critical work.

As such, service under test 100 may be topologically isolated for testing. For example, service under test 110 may be hosted and exercised within a test environment (such as a test cluster or test LAN) that is more or less separated from a live production environment. For example, a firewall may keep network traffic from the test environment away from the production environment.

Furthermore, downstream services 131-132 may be hosted or otherwise available within the production environment. Whereas, the test environment may lack access to downstream services 131-132.

Hence, downstream services 131-132 may be unavailable to service under test 110 during testing. Indeed, downstream services 131-132 may be vaporware whose actual implementation remains pending in all environments. In any case, FIG. 1 shows the absence or other unavailability of downstream services 131-132 with dashed lines.

### Example Mocking Technique

In the test environment, the unavailability of downstream services 131-132 may cause service under test 110 to malfunction or otherwise be unable to pass an integration test. Computer 100 may compensate by mocking (simulating) the availability of downstream services 131-132 in order to enable service under test 110 to properly operate.

Computer 100 accomplishes this by intercepting downstream requests 121-122 without delivering them to intended downstream services. Indeed, there may or may not be downstream service implementations that service under test 110 can actually reach from the test environment. Interception may occur by network proxy, by instrumentation of service under test 110, or by executing service under test 110 within an inversion-of-control container.

In one example, service under test 110 may reside on a developer laptop that has no network connectivity and hosts no downstream services. In another example, service under test 110 resides in a test laboratory that may lack some downstream services that might only be available in production. In another example, service under test 110 resides in a live production environment but is denied access to some or all downstream services for reliability reasons such as performance, integrity, or privacy.

In any case, computer 100 mocks the availability of downstream services 131-132 by delivering mock downstream responses 151-152 to service under test 110 in satisfaction of downstream requests 121-122. Mock downstream responses 151-152 are more or less identical to actual responses that downstream service 131-132 would have given had downstream services 131-132 actually received downstream requests 121-122.

Ideally, service under test 110 should behave the same, regardless of whether its downstream requests 121-122 are answered by actual or mock downstream responses. However, challenges for computer 100 include creation of mock downstream responses 151-152 that are more or less realistic, and determining which mock response to provide in reply to which downstream request.

To overcome these challenges and facilitate accurate integration simulation, computer 100 may contain mapping 130 that correlates downstream requests with mock downstream responses. In an embodiment, mapping 130 is contained within a test fixture for use with one or more particular integration tests.

Generally, a test harness may be any automation that properly stimulates suspect software during a test. A test harness may use a test fixture to supply known objects or other values in a way that is repeatable because service under test 110 may undergo multiple iterations of an edit-debug cycle or otherwise need repeated trials.

### Request Exemplar Matching

Regardless of how mapping 130 is packaged for deployment or embedding, internally mapping 130 contains an example request, such as 141-142, for every downstream request that service under test 110 should send during a given integration test. Example requests 141-142 are exemplars that should match actual downstream requests 121-122 that service under test 110 actually emits during a test.

Mapping 130 stores pairings of an example request to a mock downstream response. For example, example request 141 is paired (associated) with mock downstream response 151.

In that sense, mapping 130 may function as, or similar to, a lookup table. For example, mapping 130 may contain a hash table, a relational database table, or other associative structure, such as two parallel arrays, one with example requests 141-142, and another with mock downstream responses 151-152.

Furthermore in operation, example requests 141-142 are contained solely within or otherwise referenced solely by mapping 130. For example, services 110 and 131-132 and other parts of computer 100 need not ever have access to example requests 141-142.

Although downstream requests 121-122 may be sent and intercepted within computer 100, mapping 130 need not directly map actual downstream requests 121-122 to mock downstream responses 151-152. Instead, a test fixture that contains mapping 130 may compare downstream request 121 to example requests 141-142 to detect that downstream request 121 and example request 141 are equivalent.

Implementation of request equivalence may depend on intended semantics. Near one extreme may be referentially deep bitwise comparison, where a single discrepant bit may prevent equivalence.

Near the opposite extreme may be comparison of a single designated field of the requests, such as a primary key. Other implementations include comparing only a subset of fields, such as those that form a compound key.

However, request equivalence need not cover concepts such as request identity. Instead, request similarity is paramount. Mapping 130 may detect request equivalence based on hash codes, overridden polymorphic member functions such as for equality, bitwise comparison, or field-wise comparison.

A request may be a referential tree or graph of multiple objects. Request equivalence may be shallow or deep.

### Mock Response Selection

Mapping 130 may detect that downstream request 121 and example request 141 are equivalent. Having done so, and with example request 141 already associated with mock downstream response 151, mapping 130 may detect that downstream request 121 should be answered with mock downstream response 151.

As such, when downstream requests 121-122 are intercepted, mapping 130 will respectively match them with example requests 141-142 and mock downstream responses 151-152. As such computer 100 provides, to service under test 110, mock downstream responses 151-152 when service under test 110 sends downstream requests 121-122.

As such, service under test 110 may operate as if it had actually invoked downstream services 131-132. As such, service under test 110 may receive and process mock downstream responses 151-152 to perform as expected for an integration test.

However, the fidelity of performance by service under test 110 may depend upon the realism of mock downstream responses 151-152. Likewise, the realism of mock downstream responses 151-152 may depend upon the quality of their field values. For example, a mock downstream response that includes a birthdate in the future may confuse an integration test.

### Default Values

Realistic mock downstream responses may be created in a variety of ways. Computer 100 may create example requests 141-142 by assigning default values 161-162 to respective fields of example requests 141-142. Default values 161-162 may comprise generic values, such as now (current time) for timestamp fields, the numeral one for integer fields, and the letter A for string fields.

Default values 141-142 of higher quality may be extracted from a data dictionary or a schema. For example, mock downstream responses 151-152 may be XML documents that conform to an XML descriptor such as XML Schema or RELAX NG.

For example, XML Schema has standard attributes such as ‘default’ and ‘fixed’ that declare a default value. Other schema formats suffice such as an Avro schema, an interface description language (IDL) declaration such as Thrift or web service description language (WSDL), a relational schema, or a document type definition (DTD).

Default values 161-162 may confer sufficient realism upon mock downstream responses 151-152. However, one goal of integration testing is to discover boundary conditions and corner cases that unit testing missed. As such, integration testing may be exploratory with regard to finding controversial or otherwise interesting field values that expose discontinuous or other aberrant behavior of service under test 110.

### Test Cases

Another goal of integration testing is regression, which is the repetition of historically interesting tests. For example, regression may reveal that a patch that actually fixes one defect in one subsystem has caused a new defect to arise (or remission of an old defect) in another subsystem that was not patched.

Regression may accumulate known interesting tests. Exploration may create new tests that might or might not become interesting.

In both cases, test variations are important. For example, full exercise (code coverage) of a small and simple feature may involve a dozen test cases that differ only slightly from each other.

These slight differences between related tests may cause differences in the field values of downstream requests that service under test 110 emits. As such, one test may cause downstream request 121 to be sent, whereas a slightly different test may cause a downstream request to be sent that is similar, but not equivalent, to downstream request 121.

Lack of request equivalence means that mapping 130 should provide, to service under test 110, different mock downstream responses in reply to somewhat similar but unequal downstream requests. A consequence of many related test cases is that computer 100 must create many example requests and mock downstream responses and individually endow them with slight data variations. Techniques for varying data are discussed later herein.

### Fixture Encapsulation

Mapping 130 and its enclosing test fixture may be encapsulated as a pluggable component that is interchangeable (readily replaceable). This is fixture polymorphism, which may or may not share an architecture of pluggable composability with services such as services 110 and 131-132.

An encapsulated test fixture may be a true plugin that can, for example, be plugged into an inversion-of-control container. Furthermore, the plugin architecture may be provided by an application to which the service under test conforms. That is, a test harness may be crafted to implement a plugin architecture already used by the application, by a container of the application, or by other middleware infrastructure such as an ESB or other SOA having composability based on design by contract.

Although not shown, there may be alternate mappings of a same downstream request, of which mapping 130 is only one such mapping, wherein each mapping is somewhat different and so facilitates a somewhat different use case.

For example, an attempt to retrieve a stock quote may depend on whether a stock exchange is currently open, which may depend on what is the day of the week and whether it is day or night. For example, mapping 130 may simulate the daytime behavior of an open market.

For example, day mapping 130 may associate example request 141 with mock downstream response 151 to simulate a stock quote from an active market. Whereas, a night mapping that is not 130 may associate same example request 141 with a mock downstream response that is not 151, such as a market-closed response.

### Fixture Granularity

Furthermore, FIG. 1 shows service under test 110 emitting multiple downstream requests (121-122). This does not necessarily reflect test granularity.

For example, one test case may cause emission of both downstream requests 121-122. In another test case, downstream requests 121-122 may be mutually exclusive, such that the same test case may emit either of downstream requests 121-122, but not both. In a pair of other test cases, one test case may emit downstream request 121, and another test case may emit downstream request 122.

All of those test cases may be accommodated by a same mapping 130 or by separate mappings. As such mapping 130 may accommodate multiple test cases that each need only a subset of the example requests of mapping 130.

As such, the example requests and mock downstream responses of mapping 130 may be the union of all example requests and mock downstream responses needed by all test cases that mapping 130 supports. However, some implementations of mapping 130 may be unable to accommodate some combinations of test cases. For example, different test cases that each expects a different mock downstream response for a same example request may need separate mappings, such as the day and night mappings discussed above.

### Example Mocking Process

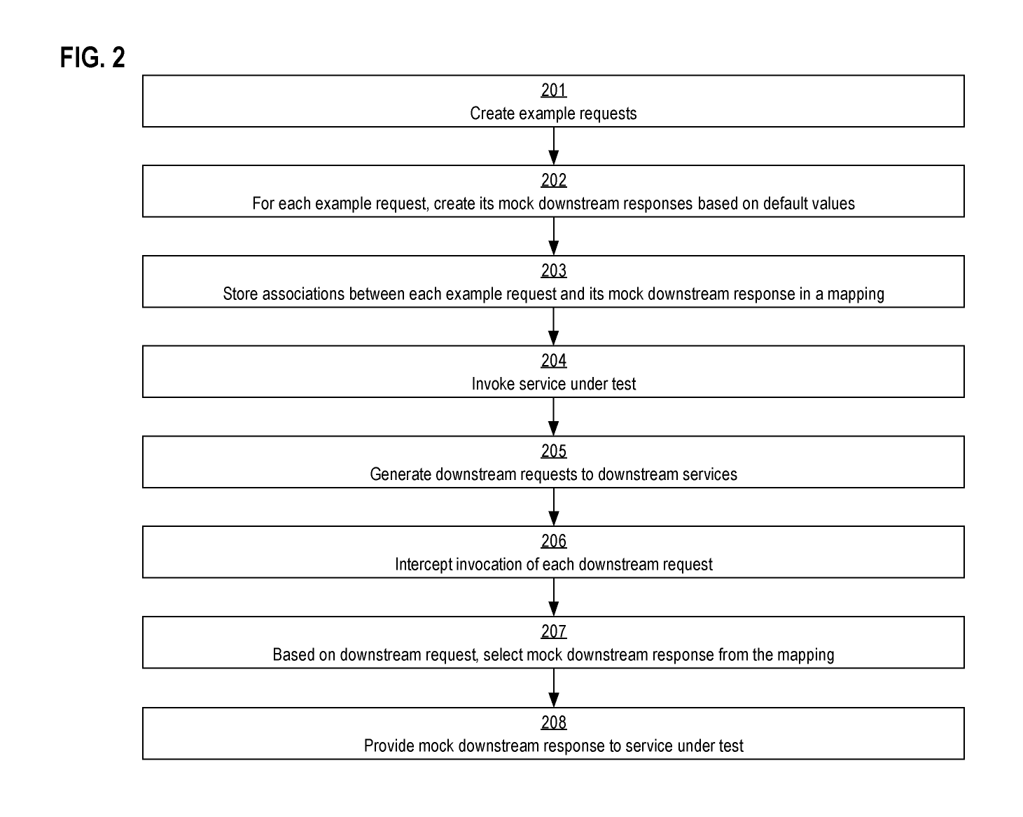

FIG. 2 is a flowchart that depicts an example process for creating mock responses based on default data and mapping actual requests to those mock responses so that a service under test may be exercised within a simulated integration. FIG. 2 is discussed with reference to computer 100.

Steps 201-203 are preparatory in the sense that they configure mapping 130 for particular test(s). However, there may be time or space costs of configuring mapping 130 that may be deferred or avoided. That is, configuration established by steps 201-203 might not be needed until subsequent steps, such as steps 207-208. As such, some behavior of steps 201-203 may be lazily deferred until needed by a subsequent step. Laziness and avoidance are detailed later herein.

In step 201, example requests to downstream services are created. This does not actually invoke downstream services. Indeed, downstream services need not actually be implemented.

For example, computer 100 may create example requests 141-142 and configures them to invoke respective downstream services 131-132. How many example requests and having which field values depends on which test cases are supported by mapping 130.

Example requests 141-142 may be declaratively constructed from earlier recordings of actual requests or from data dictionaries and schemas. Example requests 141-142 may be imperatively constructed by executing procedural logic such as custom scripts and/or property setters of example requests 141-142. Techniques for creating example requests are discussed later herein.

In step 202, a mock downstream response is created, based on default values, for each example request. For example, computer 100 creates mock downstream responses 151-152, for respective example requests 141-142, based on default values such as 161-162.

Which mock downstream responses and having which field values depends on which test cases are supported by mapping 130. Mock downstream responses 151-152 may be declaratively constructed from earlier recordings of actual responses or from data dictionaries and schemas.

Mock downstream responses 151-152 may be imperatively constructed by executing procedural logic such as custom scripts and/or property setters of mock downstream responses 151-152. Techniques for creating mock downstream responses are discussed later herein.

In step 203, associations between each example request and its mock downstream response are stored in the mapping. For example, computer 100 stores associations between example requests 141-142 to respective mock downstream responses 151-152 within mapping 130. For example, mapping 130 may contain a hash table that maps each example request to a respective mock downstream response.

In step 204, a service under test is invoked. For example, computer 100 may stimulate service under test 110 to induce it to perform according to a test case.

For example, service under test 110 may receive a command, a message, or a signal from a test harness or other part of computer 100. This may cause service under test 110 to process inputs, check environmental conditions, perform custom logic, delegate work, and perhaps eventually emit a reply such as a success or error code.

In step 205, the service under test reacts to being invoked by generating downstream requests to downstream services. For example, service under test 110 may attempt to delegate work to downstream services 131-132 by sending downstream requests 121-122. However, downstream requests 121-122 are not actually delivered to downstream services 131-132. That is in step 206, each downstream request is intercepted.

For example, computer 100 may intercept downstream requests 121-122. Interception may occur by network proxy, by instrumentation of service under test 110, or by executing service under test 110 within an inversion-of-control container.

In a preferred embodiment, a container inverts control such that some or all traffic in and out of service under test 110 may be automatically manipulated. For example, downstream requests that are emitted by service under test 110 may be intercepted and diverted away from intended downstream services. Likewise, mock downstream responses may be locally injected into service under test 110 as if the mock downstream responses had arrived from a remote service.

In step 207 and based on an intercepted downstream request, a mock downstream response is selected from the mapping. For example and by comparison, computer 100 detects that downstream request 121 is equivalent to example request 141. For example, computer 100 may compare downstream request 121 to each example request of mapping 130, one after the other, until eventually a match between downstream request 121 and example request 141.

Computer 100 uses example request 141 to look up mock downstream response 151 within mapping 130. For example, the whole of example request 141 may act as a lookup key. Alternatively, parts of example request 141 may be extracted and aggregated to form a compound key that may act as a lookup key.

In step 208, the selected mock downstream response is provided to the service under test. For example, computer 100 provides mock downstream response 151 to service under test 110.

For example, computer 100 may provide mock downstream response 151 by providing a reference (pointer or address) to mock downstream response 151. Alternatively, a copy of mock downstream response 151 may be provided (by value).

The exact mechanics of providing mock downstream response 151 are implementation dependent and likely to use the same delivery mechanism as service under test 110 used to send downstream requests 121-122. For example if downstream request 121 is synchronously sent over a duplex inter-process connection, such as a TCP connection to a network proxy, then computer 100 may use the network proxy to synchronously deliver mock downstream response 151 over the same TCP connection, but in the opposite direction.

Likewise, if downstream request 121 is asynchronously sent, such as by JMS, then computer 100 may use JMS to asynchronously deliver mock downstream response 151 via JMS, although likely to a different message queue or publish-subscribe topic. Likewise, if downstream request 121 is intercepted by instrumentation or control inversion, then the same mechanism may be used to inject mock downstream response 151 into service under test 110.

However, an implementation may have asymmetry between request interception and response delivery. For example, a natural combination is to use bytecode instrumentation of service under test 110 to intercept downstream request 121 and control inversion or message queuing to inject mock downstream response 151 into service under test 110.

Even though the steps of FIG. 2 may test a simulated integration, service under test 110 may consume (receive and process) mock downstream response 151 in the same way as if computer 100 were handling a live transaction within a production ecosystem. Indeed, achieving constant behavior of service under test 110, regardless of whether in test or production, increases the validity and value of the testing.

Finally a test harness or other part of computer 100 may inspect any results of invoking service under test 110 to detect whether the test case succeeded or failed. For example, service under test 110 may emit a reply or an answer or cause some other observable side effect.

As such, the test harness may compare any reply or side effect to an expected result to detect success or failure of the test. Computer 100 may alert or record actual results, expected results, and test success or failure. For example, all of downstream requests 121-122 and mock downstream responses 151-152 may be recorded for post-mortem forensics of a failed test.

Furthermore with sufficient thread safety, mapping 130 may support some degree of concurrency. For example, the underlying hash table or other data structures of mapping 130 may be inherently thread safe when used immutably (read only).

For example, mapping 130 may concurrently support multiple tests from multiple services under test. Also, mapping 130 may concurrently process downstream requests 121-122.

Mapping 130 may support some degree of pipelining, such as concurrently performing different steps of FIG. 2 for different downstream requests. For example, computer 100 may match (step 205) downstream request 121 to example request 141 at the same time that computer 100 intercepts (step 206) downstream request 122. Concurrency techniques are discussed later herein.

### Flexible Mapping

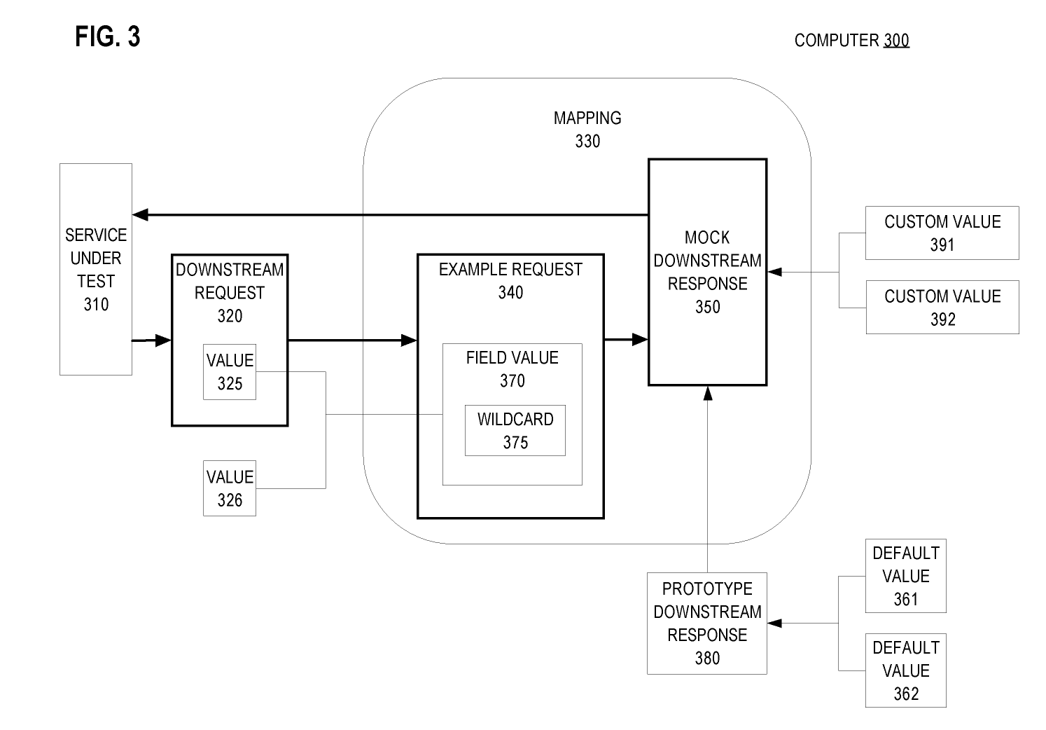

FIG. 3 is a block diagram that depicts an example computer 300 that incorporates request wildcarding, response cloning, and response customization to achieve flexibility and convenience, in an embodiment. Computer 300 may be an implementation of computer 100.

Computer 300 includes mapping 330 and service under test 310. Service under test 310 may be impacted by a common testing complication that arises when an extensive range of inputs may cause totally or nearly identical results. For example, service under test 310 may emit any of an extensive range of similar downstream requests, such as 320, and expect totally or nearly identical mock downstream responses, such as 350. For example, only theory limits the number of malformed URLs, corrupted request payloads, and other aberrant downstream requests. Yet, all of those downstream requests may be answered by a same mock downstream response, such as a generic response that indicates an error, such as an HTTP 404 response.

That is, there may be a many-to-one correlation of downstream requests to a same mock downstream response. For example, multiple other (not shown) downstream requests, in addition to downstream request 320, may need correlation with mock downstream response 350.

Mapping 330 achieves many-to-one correlation by endowing example request 340 with a degree of data abstraction. For example, example request 340 may contain various values within various fields, such as field value 370.

Despite always expecting a same mock downstream response 350, similar downstream requests may differ slightly for some their fields. For example, downstream request 320 may have value 325 for a given field, whereas an almost identical downstream request (not shown) may have different value 326 for the same field.

That is, example request 340 should allow some variability when attempting to match field value 370. Furthermore, such variability may be limited.

For example, service under test 310 may expect a downstream service to treat adults differently from children. For example, a request field may be a birth year.

If the first digit of the birth year is a ‘2’, as with 2008, then a child is indicated. Whereas if the first digit of the birth year is a ‘1’, as with 1970, then an adult is indicated.

For adults, mock downstream response 350 may be expected. Whereas for children, a different (not shown) mock downstream response is expected.

Mapping 330 may accommodate such parsing with wildcards, such as 375. For example, field value 370 may contain a constant ‘1’ followed by wildcard 375, which may have placeholder characters.

For example, an asterisk within wildcard 375 may match any character. As such, field value 370 may be a literal such as “1***”, to match all years of the prior millennium.

In an embodiment, field value 370 may conform to a pattern-matching grammar. For example, field value 370 may contain a regular expression that contains a variety of wildcardings.

The efficiency of mapping 330 or any test fixture may be evaluated according to time and space consumed during test case execution. However, a more valuable measurement of the efficiency of mapping 330 may derive from its total cost of ownership (TCO).

For example, the better of two mappings that accomplish identical results may be the mapping that is easier (quicker, less labor intensive) to develop and maintain. Wildcarding is only one way that computer 300 may ease test development. Another way is as follows.

Slight differences between related test cases may cause differences in the field values of downstream requests that service under test 310 emits. As such, one test may cause downstream request 320, whereas a slightly different test may cause a downstream request that is similar, but not equivalent, to downstream request 320.

These different downstream requests may expect slightly different mock downstream responses. As such, mapping 330 may contain many slightly different (not shown) mock downstream responses.

However, manually crafting many slightly different mock downstream responses may be labor intensive and prone to human error. Computer 300 may enable hand crafting or other creation of prototype downstream response 380 that may act as a cookie-cutter template from which other mock downstream responses, such as 350, may be cloned.

All of the default-value machinery described earlier herein may endow prototype downstream response 380 with reasonable generic default values, such as 361-362. As such, prototype downstream response 380 is created with default values, and clones such as mock downstream response may inherit copies of those default values.

Data copying from prototype to clone may be shallow or deep. Deep copying achieves isolation by endowing each mock response clone with its own private copy of data. As such, customization (specialization by modification) of one clone is not propagated to other clones of a same prototype.

Shallow copying facilitates sharing, thereby reducing memory demand. For example, each mock downstream response may be a logical graph, logical tree, or other composite or aggregation of multiple component objects.

If clones are individually customized, then each clone must have a separate copy of its component objects for independent customization. Whereas, clones might only be partially customized by modifying only some component objects and not others. To save memory and reduce cache thrashing, a single instance of an unmodified component object may be shared by reference by multiple mock downstream responses.

Mapping 330 may be scripted with custom logic that guides the creation and population of mapping 330. That logic may receive (or create from scratch) prototype downstream response 380 and then repeatedly use prototype downstream response 380 as a source of clones.

However, perfectly identical clones may be unable to cover slightly different test cases. Instead, each clone may need dedication to (including data customization for) a respective variant test case.

The custom logic of mapping 330 may also perform such customization. For example, field setters may be invoked with scripted values, such as custom values 391-392.

Furthermore, the custom logic of mapping 330 may dynamically compute custom values 391-392. For example, custom value 391 may be for a timestamp field that is reassigned to now (the current time) whenever it is read.

Because mapping 330 and its enclosing test fixture may be implemented with a general-purpose programming language such as Java or JavaScript, a rich imperative syntax may be available that includes various control flow idioms. For example, a for loop may accomplish assigning successive integer values to a same field of many clones using only a single line (or statement) of source code

In an embodiment, the enclosing test fixture of mapping 330 may be implemented as a Java class, such as ProposalFixture, that subclasses reusable and fully or mostly operational base class, such as RestliFixture. The base class may provide the data structure that stores mapping 330 in a generalized way. For example, lookup may achieve constant time with a hash table or an array of keys aligned to an array of values.

In an embodiment, the following Java snippet creates an association between example request 340 and mock downstream response 350. For example, the test fixture base class, RestliFixture, may implement a method, addResponse, that a subclass such as ProposalFixture may invoke according to this Java snippet:

addResponse(exampleRequest340,mockResponse350);

Furthermore, the following may be a Java snippet of the test fixture, ProposalFixture, that creates two example requests within exampleRequestArray, a prototype response as prototypeResponse, and (within mockResponseArray) two customized clones of the prototype response. The Java snippet inserts, into mapping 330, an association between each example request in exampleRequestArray and the respective customized clone mock response in mockResponseArray:

```
public class ProposalFixture extends RestliFixture {
  @Override
  public void generateFixture( ) {
    // Create example requests for matching
    GetRequest<PremiumCredits> [ ] exampleRequestArray = new
    GetRequest<PremiumCredits>[2];
    for (int index = exampleRequestArray.length ; 0 < index--; )
      exampleRequestArray[index] =
        new PremiumCreditsBuilders( ).get( );
    // Initialize similar example requests of unequal colors
    for (int index = exampleRequestArray.length ; 0 < index--; )
      exampleRequestArray[index].setColor(
        new String[ ]{ “green”, “blue” } [index]);
    // Prepare prototype response
    IntegerMap integerMap = new IntegerMap( );
    integerMap.put(CreditType.INMAIL.toString( ),
      Integer.valueOf(5)); // Default value
    PremiumCredits prototypeResponse=new PremiumCredits( );
    prototypeResponse.setCredits(integerMap);
    // Clone mock responses from prototype
    PremiumCredits [ ] mockResponseArray = new
    PremiumCredits[2];
    for (int index = mockResponseArray.length ; 0 < index--; )
      mockResponseArray[index] =
        prototypeResponse.deepClone( );
    // Customize mock responses with individualized credits
    for (int index = mockResponseArray.length ; 0 < index--; )
      mockResponseArray[index].getCredits( ).put(
        CreditType.INMAIL.toString( ),
        Integer.valueOf(index));
    // Add the mapping associations
    for (int index = mockResponseArray.length ; 0 < index--; )
      addResponse(exampleRequestArray[index],
        mockResponseArray[index]);
  }
}
```

In an embodiment, mapping 330 may associate multiple alternate mock downstream responses to a same example request. For example, the specific alternate mock downstream response that mapping 330's test fixture selects to provide to service under test 310 may depend on dynamic conditions. In an embodiment, mapping 330 uses multiple to one-to-one associations to approximate a one-to-many-alternates association. For example, mapping 330 may nest hash tables or use a single hash table with compound keys.

For example, mapping 330 may detect a role or privilege of a user or principal (likely imaginary during testing) is using service under test 310. For example if service under test 310 is embedded within a servlet, then role-based access control (RBAC) may be available. For example, mapping 330 may provide one mock downstream response when a user of sufficient privilege is involved. Whereas, a mock downstream response that indicates access denial may be provided when a user of insufficient privilege is involved.

Furthermore, the custom logic of mapping 330 may dynamically compute custom values 391-392 based on which downstream request is involved, such as 320. For example, custom value 391 may be for a transaction identifier field and may be reassigned a new value based on a same transaction identifier field in downstream request 320.

In that way, an actual value may flow roundtrip from service under test 310 to mapping 330 and then back to service under test 310. For example, service under test 310 may use the identifier to correlate a request with its response.

Similar scripting of cloning and customization may be used to ease creation of many example requests. For example and although not shown, example request 340 may be a customized clone of a prototype example request.

Furthermore, cloning and customization of whole mappings may be supported. For example and although not shown, mapping 330 may itself be a customized clone of a prototype mapping.

### Integration Testing

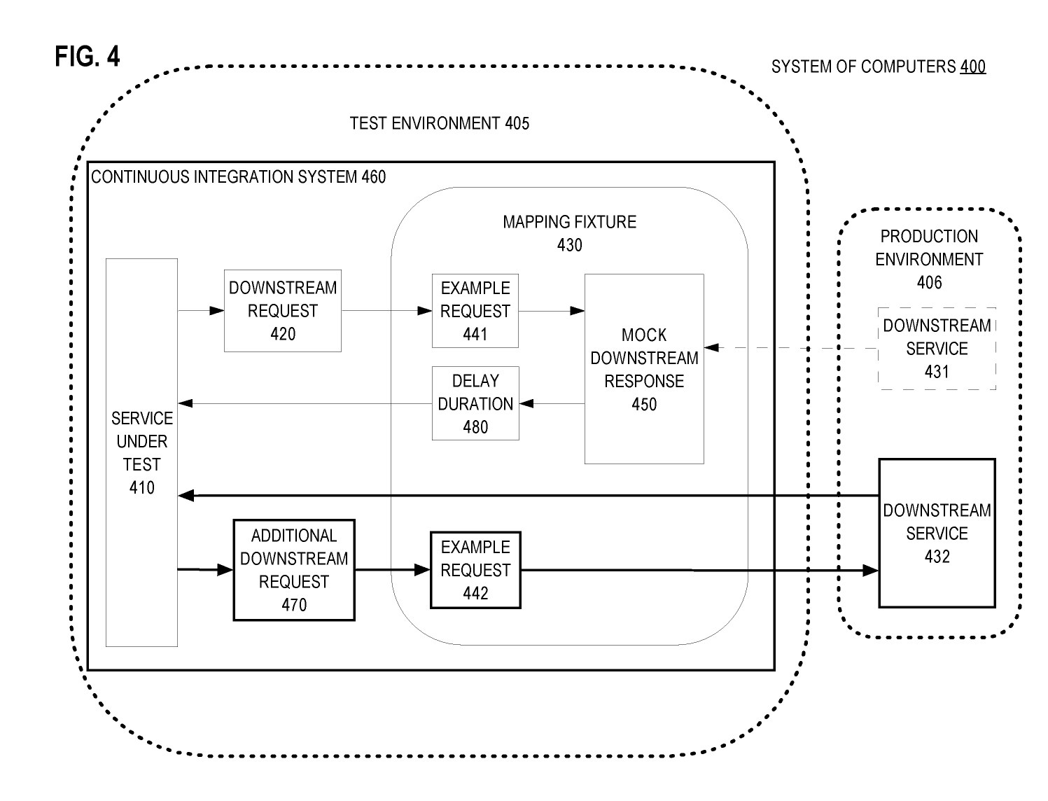

FIG. 4 is a block diagram that depicts example system of computers 400 that performs integration testing, in an embodiment. System 400 is comprised of networked computers, at least one of which may be an implementation of computer 100.

At least one computer of system 400 occupies test environment 405. Test environment 405 may be an integration testing laboratory where unreleased software, such as service under test 410, is tested for interoperability with downstream services that may or may not be available in test environment 405.

Continuous integration system 460 is deployed on at least one computer of test environment 405 is. Continuous integration system 460 may combine a software build system with a test automation harness. For example, continuous integration system 460 may build software by retrieving source code from version control, compiling the source code into binaries, and packaging the binaries into deliverables.

Continuous integration system 460 automates integration testing. For example, continuous integration system 460 may deploy a build of service under test 410 onto at least one computer of test environment 405 and then administer scripted tests such as unit tests, integration tests, and system tests.

Performing an integration test may involve starting a test harness, inversion-of-control container, or test application server to host service under test 410, creating and embedding mapping fixture 430 into the test harness, and then exercising service under test 410. Embedding may involve configuration, such as Java bean wiring, to interconnect service under test 410, mapping fixture 430, and the test container.

Continuous integration system 460 may dispatch a command or otherwise call upon service under test 410 to execute. When service under test 410 executes, it may create and send downstream requests, such as 420 and 470.

However, mapping fixture 430 may be configured to treat downstream requests 420 and 470 differently. For example, downstream requests 420 and 470 are configured to invoke different respective downstream services 431-432.

In the example shown, both of downstream services 431-432 occupy at least one computer within production environment 406. Production environment 406 may host live systems for online transaction processing (OLTP), such as web sites, applications, and databases.

Even though service under test 410 occupies test environment 405, service under test 410 may access downstream services that occupy production environment 406. However, this access may be partial.

For security, privacy, or performance reasons, some downstream services of production environment 406 may be unavailable to test environment 405. For example, downstream service 432 is available to test environment 405, but because downstream service 431 is unavailable, it is drawn with dashed lines.

Thus, mapping fixture 430 may be configured to provide mock downstream responses, such as 450, when service under test 410 invokes downstream service 431, such as by sending downstream request 420.

Furthermore, mapping fixture 430 may be configured to actually use downstream service 432. For example, mapping fixture 430 may maintain a set of example requests, such as 442, for which a response should not be mocked.

In an embodiment, a same hash table that maps example requests, such as 441, to mock downstream responses, such as 450, may also maintain the set of example requests, such as 442, for which a response should not be mocked. For example, the hash table may map example request 442 to null.

When mapping fixture 430 intercepts additional downstream request 470, mapping fixture 430 may detect that additional downstream request 470 matches example request 442, and that example request 442 is mapped to null. Mapping fixture 430 may react to the null by sending additional downstream request 470 to downstream service 432 and allowing downstream service 432 to send an actual downstream response (not shown) back to service under test 410.

In an embodiment, mapping fixture 430 need not be specially populated (e.g. with nulls) to cause an actual downstream service to be invoked. For example, mapping fixture 430 may detect into which environment, 405 or 406, is mapping fixture 430 deployed. If mapping fixture 430 recognizes that it is deployed within test environment 405, then mapping fixture 430 may provide mock downstream responses to service under test 410. Whereas, if mapping fixture 430 recognizes that it is deployed within production environment 406 with access to many or all services, then mapping fixture 430 may behave more as a passive conduit of traffic. For example, mapping fixture 430 may contain a mock downstream response for each example request, ignore the stored mock downstream responses, and instead allow downstream requests to flow to actual downstream services 431-432 and actual downstream responses to flow back to service under test 410.

Mixing actual and mocked services within an integration test may introduce latencies that distort the timing of the downstream responses. For example, mock downstream response 450 may be provided without any latency from a network or downstream service. Whereas, transport and execution of additional downstream request 470 may incur such latencies.

Such latencies may cause temporal distortions that may alter the ordering in which service under test 410 receives actual and mock downstream responses. A reordering of downstream responses may cause a race condition that causes service under test 410 to malfunction and fail its test.

Mapping fixture 430 may artificially delay a mock downstream response to regain natural timing as would occur in production. Within mapping fixture 430 is delay duration 480 that specifies how long mock downstream response 450 should be delayed to simulate production latency.

Tuning (adjusting) the delay durations may provoke different race conditions. As such, delay durations themselves may benefit from exploratory tuning to expose latent defects. For example, continuous integration system 460 may repeat a same test case but with a different value for delay duration 480. Likewise, mapping fixture 430 may buffer and reorder mock downstream responses in exploration for race conditions.

### Configuration Avoidance and Deferral

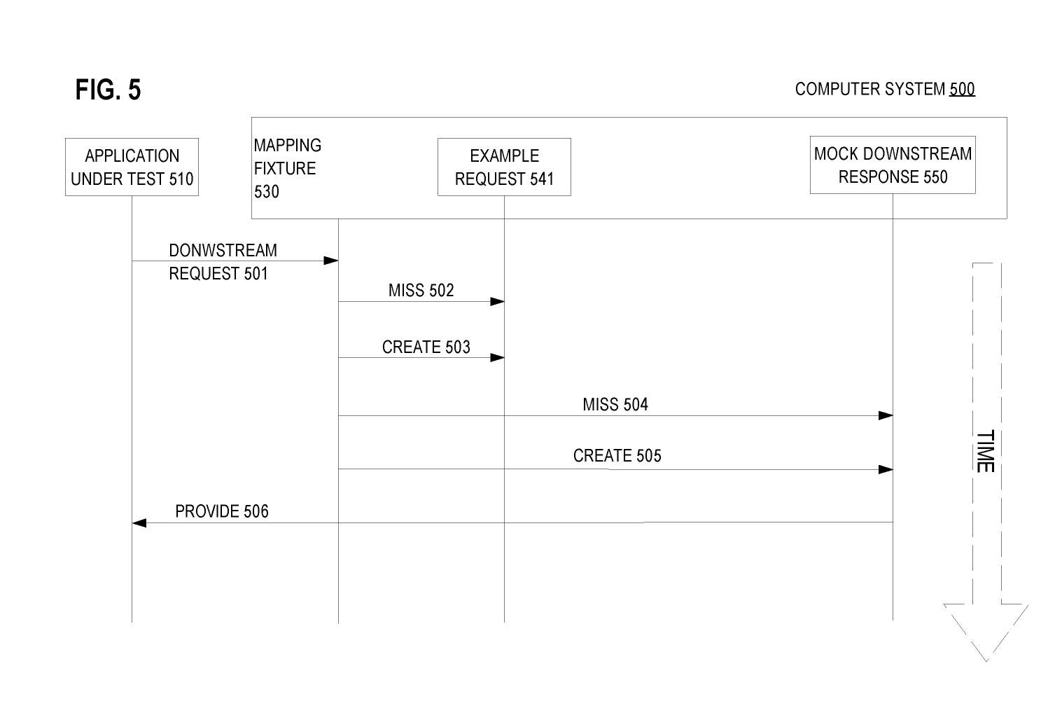

FIG. 5 is a block diagram that depicts an example computer system 500 that decouples mapping creation from mapping population. Such decoupling may avoid and defer portions of the configuring of a mapping fixture, in an embodiment. Computer system 500 may be an implementation of computer 100.

Computer system 500 contains application under test 510 and mapping fixture 530. Application under test 510 may be a backend web application, such as a hosted Google Play application.

During a simulated integration test of application under test 510, mapping fixture 530 may intercept and process downstream request 501 that is sent by application under test 510. How mapping fixture 510 reacts to downstream request 501 may depend on whether mapping fixture 530 is cold or warm.

For example, mapping fixture 510 may engage in a series of interactions 502-506 that occur in time within FIG. 5 in a downward arrangement. That is, the passage of time flows downward, as shown by the large dashed arrow.

Mapping fixture 530 is cold when it is first created as more or less empty of example requests and mock downstream responses. Mapping fixture 530 may lazily configure itself by constructing example requests and mock downstream responses only when needed.

Whereas eager configuration, as an alternative, would fully populate mapping fixture 530 upon its creation at the beginning of a test case. For example, mapping fixture 530 may contain dozens or hundreds of example requests and mock downstream responses whose construction demands time and space.

Furthermore with eager configuration, application under test 510 cannot be invoked until mapping fixture 530 is fully populated. Whereas, lazy configuration allows application under test 510 to be invoked even if mapping fixture 530 is not yet populated (although the primary benefit is configuration avoided).

For example, mapping fixture 530 may receive downstream request 501 and attempt to match it against example requests. However, mapping fixture 530 might not yet have created all of its example requests.

As such, mapping fixture 530 may compare downstream request 501 against however many example requests are already created. Furthermore, the comparing may fail because downstream request 501 should match example request 541, which is not yet created.

As such, mapping fixture 530 may also need to create additional example requests, one by one, such as 541, until a match occurs. This is lazy creation of example requests.

In a sense, mapping fixture 530 acts as a cache of example requests and mock responses that it has already created. The hash table discussed earlier herein may suffice as a cache implementation.

When mapping fixture 530 needs to access an example request or a mock downstream response, mapping fixture 530 may find the request or response within the cache of mapping fixture 530. A request or response may be absent from the cache.

For example, example request 541 may be absent when mapping fixture 530 needs it, which is shown as miss 502. Mapping fixture 530 may compensate for any miss by creating the missing object as it otherwise would have had configuration been eager.

For example, mapping fixture 530 responds to miss 502 by constructing and caching example request 541, shown as create 503. However, what is shown as a single create 503 may actually be a sequence of creates of other example requests until eventually example request 541 is created. For example, lazy and eager populations of mapping fixture 530 may create example requests in a same ordering.

Mapping fixture 530 compares downstream request 501 to example request 541 and detects that they are equivalent. As such, mapping fixture 530 looks within the cache for a mock downstream response, such as 550, that is associated with example request 541.

However, mock downstream response 550 may be absent from the cache, in which case mapping fixture 530 may construct and cache it, which is shown as create 505. At that point, mapping fixture 530 may make mock downstream response 550 available to application under test 510, shown as provide 506.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

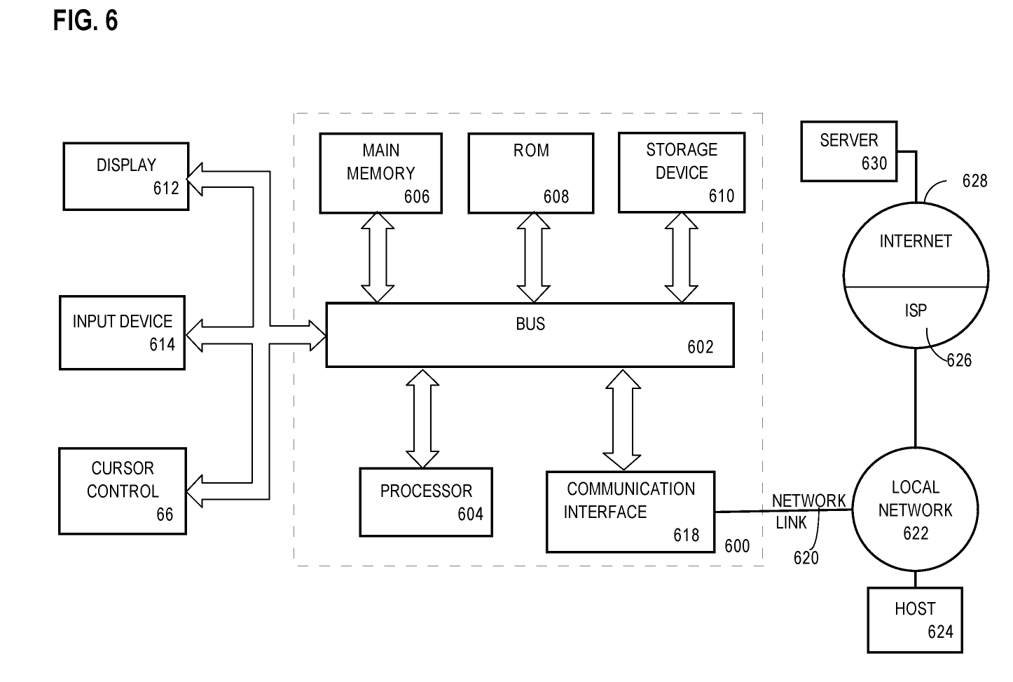

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 66, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
creating a plurality of example requests, wherein each example request of the plurality of example requests invokes, when processed, a downstream service of a plurality of downstream services;
for each example request of the plurality of example requests:
automatically creating a mock downstream response,
storing, in a mapping, an association between said each example request and the mock downstream response;
invoking a service under test;
generating, by the service under test and responsive to the invoking, a plurality of downstream requests to one or more downstream services;
for each downstream request of the plurality of downstream requests:
intercepting an invocation of said each downstream request,
selecting, from the mapping, based on said each downstream request, a particular mock downstream response, and
providing the particular mock downstream response to the service under test;
wherein the method is performed by one or more computing devices.

2. The method of claim 1, wherein automatically creating the mock downstream response further comprises at least one of: creating the mock downstream response based on one or more default values, or customizing the mock downstream response based on one or more custom values.

3. The method of claim 2 wherein creating the mock downstream response comprises creating a clone of a prototype downstream response.

4. The method of claim 2 wherein at least one of the one or more custom values is dynamically generated.

5. The method of claim 2 wherein at least one of the one or more custom values is based on a value within in at least one downstream request of the plurality of downstream requests.

6. The method of claim 1 wherein creating the mock downstream response is responsive to intercepting at least one of said plurality of downstream requests.

7. The method of claim 1 wherein creating the plurality of example requests is responsive to intercepting at least one of said plurality of downstream requests.

8. The method of claim 1 wherein the service under test comprises a web application.

9. The method of claim 1 wherein:
each example request of the plurality of example requests contains one or more values;
selecting, based on said each downstream request, the particular mock downstream response comprises matching a subset of the one or more values of said each downstream request to one or more values of an example request of the plurality of example requests.

10. The method of claim 9 wherein a value of an example request of the plurality of example requests contains a wildcard that matches many values.

11. The method of claim 1, further comprising:
generating, by the service under test and responsive to the invoking, one or more additional downstream requests to one or more downstream services;
for each additional downstream request of the one or more additional downstream requests:
intercepting an invocation of said each additional downstream request,
detecting, based on said each additional downstream request, that said each additional downstream request should invoke an actual service;
in response to detecting that said each additional downstream request should invoke an actual service, using said each additional downstream request to invoke the actual service.

12. The method of claim 11 wherein detecting that said each additional downstream request should invoke an actual service comprises detecting that the service under test is operating in a particular deployment environment.

13. The method of claim 1 wherein providing the mock downstream response to the service under test comprises, based on the mapping, delaying providing the mock downstream response for a duration.

14. The method of claim 1 wherein:
the method further comprises repeating the method of claim 1 at least once for a same test case;
an ordering in which mock downstream responses are provided to the service under test differs between repetitions of the method of claim 1 for the same test.

15. The method of claim 1 wherein creating a mock downstream response that is based on default values comprises reading a data dictionary or a schema.

16. The method of claim 15 wherein reading a schema comprises reading at least one of: an Avro schema, an interface description language (IDL) declaration [eg, Thrift or WSDL], an extensible markup language (XML) schema, a relational schema, or a document type definition (DTD) declaration.

17. The method of claim 1 wherein selecting the particular mock downstream response from the mapping is further based on a role or a privilege of a user.

18. The method of claim 1 wherein invoking the service under test is performed by a continuous integration system.

19. One or more non-transitory machine-readable media storing:
first instructions that, when executed by one or more processors, cause creating a plurality of example requests, wherein each example request of the plurality of example requests is configured to invoke a downstream service of a plurality of downstream services;
second instructions that, when executed by one or more processors, cause for each example request of the plurality of example requests:
creating a mock downstream response that is based on default values,
storing, in a mapping, an association between said each example request and the mock downstream response;
third instructions that, when executed by one or more processors, cause invoking a service under test;
fourth instructions that, when executed by one or more processors, cause generating, by the service under test and responsive to the invoking, a plurality of downstream requests to one or more downstream services;
fifth instructions that, when executed by one or more processors, cause for each downstream request of the plurality of downstream requests:
intercepting an invocation of said each downstream request,
selecting, from the mapping, based on said each downstream request, a particular mock downstream response, and
providing the particular mock downstream response to the service under test.

20. A computer comprising:
a memory configured to store example requests, mock downstream responses, and a mapping from example requests to mock downstream responses;
a processor connected to the memory and configured to:
create a plurality of example requests, wherein each example request of the plurality of example requests is configured to invoke a downstream service of a plurality of downstream services;
for each example request of the plurality of example requests, performing:
creating a mock downstream response that is based on default values,
storing, in a mapping, an association between said each example request and the mock downstream response;
invoking a service under test;
generating, by the service under test and responsive to the invoking, a plurality of downstream requests to one or more downstream services;
for each downstream request of the plurality of downstream requests:
intercepting an invocation of said each downstream request,
selecting, from the mapping, based on said each downstream request, a particular mock downstream response, and
providing the particular mock downstream response to the service under test.
